(19) United States
(12) Patent Application Publication
(10) Pub. No.: US 2015/0067303 A1
(43) Pub. Date: Mar. 5, 2015

(54) INPUT DATA AGGREGATION PROCESSING APPARATUS, SYSTEM AND METHOD

(71) Applicant: Hitachi, Ltd., Tokyo (JP)

(72) Inventors: Tomoya FUJIWARA, Tokyo (JP); Tatsuhiko MIYATA, Tokyo (JP); Jun YOSHIHARA, Tokyo (JP); Yoshiki MATSUURA, Tokyo (JP)

(73) Assignee: Hitachi, Ltd., Tokyo (JP)

(21) Appl. No.: 14/322,360

(22) Filed: Jul. 2, 2014

(30) Foreign Application Priority Data
Sep. 3, 2013 (JP) 2013-182070

(51) Int. Cl. G06F 9/38

(52) U.S. Cl. CPC G06F 9/3836
USPC 712/220

(57) ABSTRACT

To improve usability and a processing speed by waiting for a string of information associated with each other, and appropriately aggregating data satisfying a specific condition when outputting the data, and retaining and storing the aggregated data. In a case where a string of information originally associated with each other is arrival, separately, a data input/output unit determines a processing pattern on the basis of information on an input source. A data processing unit implements a processing condition for waiting for the associated information, individually, controls the storage of data in conformity with the processing condition, and aggregates and retains the string of data, and outputs an aggregation result. Also, the data processing unit can delete the string of unnecessary data in a lump.

### CLAIM OF PRIORITY

The present application claims priority from Japanese patent application JP 2013-182070 filed on Sep. 3, 2013, the content of which is hereby incorporated by reference into this application.

### BACKGROUND OF THE INVENTION

1. Field of the Invention

The present invention relates to an input data aggregation processing apparatus, system, and method, and more particularly to an input data aggregation processing apparatus, system, and method for executing aggregation and output processing of a string of input data

2. Description of the Background Art

That a string of data is converted, divided, and aggregated on the basis of a specific rule for plural pieces of input data will be required on various business scenes. On such scenes, a technique has been studied in which the plural pieces of data different in format and structure is collected, a data reconstruction such as conversion, division, or aggregation is conducted on the data, and the data is output with the format and the structure subsequently required.

The background art of this technical field is disclosed in JP-A-2002-335351 (Japanese Patent No. 4131908) .

JP-A-2002-335351 (Japanese Patent No. 4131908) discloses a technique in which when a user uses a service of a carrier, a use information record per one session which is received from a use information source of the session is generated and output as a partial use information record sequentially corresponding to the session still in progress for the purpose of acquiring use information of a communication in near-real time, and conducting billing processing.

### SUMMARY OF THE INVENTION

When the above-mentioned method is used, in a case where a string of data having start and ending information originally associated with each other arrives at an input unit, separately, the reusability of information may be lowered because those pieces of information is retained and stored, independently. Also, a processing efficiency may be adversely affected by outputting data that satisfies a specific condition. Further, because input information is stored without sorting out information, there arises such a problem that a resource is unnecessarily consumed. In addition, even in the existing big data business, a use scene that how to use and a utilization manner are sought once all of data is stored is frequently assumed. This leads to such a problem that the resource is unnecessarily used in extracting significant information from a large quantity of data.

The present invention has been made in view of the above viewpoint, and therefore aims at improving usability and a processing speed by waiting for a string of information associated with each other, and appropriately aggregating data satisfying a specific condition when outputting the data, and retaining and storing the aggregated data.

According to the first solving means of the present invention, there is provided an input data aggregation processing apparatus, comprising:

a pattern determination table that stores a processing condition pattern number, for an input source in advance;

a processing condition list that stores a start condition, an ending condition and an output destination, an intermediate condition for conducting aggregation processing at an intermediate point and the output destination, for the processing condition pattern number;

an intermediate data table that stores a value to be aggregated and a completion flag, for a key value; and

a processing unit,

wherein the processing unit reads the respective divided input data in a case where a string of data having start and ending information separately arrives at the processing unit from an external system,

the processing unit discriminates whether the input data is transmitted from any input source,

the processing unit acquires a key value for identifying the string of data, a determination value in advancing processing, the value to be aggregated, and the processing condition pattern number, from the input data and the input source, with reference to the pattern determination table,

the processing unit registers the key value and the value to be aggregated which are acquired from the input data, and the completion flag set to “not output” in the intermediate data table, and

the processing unit conducts ending processing for calculating an aggregation result obtained by aggregating the values to be aggregated of one or a plurality of records of the same key value as the key value of the input data from the intermediate data table when the determination value satisfies the ending condition or the intermediate condition with reference to the processing condition list, completion flag edition processing for updating the completion flag of the one or the plurality of records as “already output”, and output processing for outputting the key value and the aggregation result to an output destination obtained with reference to the processing condition list.

According to the second solving means of the present invention, there is provided an input data aggregation processing system, comprising an aggregation processing server which comprises:

a pattern determination table that stores a processing condition pattern number, for an input source in advance;

a processing condition list that stores a start condition, an ending condition and an output destination, an intermediate condition for conducting aggregation processing at an intermediate point and the output destination, for the processing condition pattern number;

an intermediate data table that stores a value to be aggregated and a completion flag, for a key value; and

a processing unit,

wherein the processing unit of the aggregation processing server reads the respective divided input data in a case where a string of data having start and ending information separately arrives at the processing unit from an external system,

the processing unit discriminates whether the input data is transmitted from any input source,

the processing unit acquires a key value for identifying the string of data, a determination value in advancing processing, the value to be aggregated, and the processing condition pattern number, from the input data and the input source, with reference to the pattern determination table,

the processing unit registers the key value and the value to be aggregated which are acquired from the input data, and the completion flag set to “not output” in the intermediate data table, and

the processing unit conducts ending processing for calculating an aggregation result obtained by aggregating the values to be aggregated of one or a plurality of records of the same key value as the key value of the input data from the intermediate data table when the determination value satisfies the ending condition or the intermediate condition with reference to the processing condition list, completion flag edition processing for updating the completion flag of the one or the plurality of records as “already output”, and output processing for outputting the key value and the aggregation result to an output destination obtained with reference to the processing condition list.

According to the third solving means of the present invention, there is provided an input data aggregation processing method in an input data aggregation processing apparatus, the input data aggregation processing apparatus which comprises:

a pattern determination table that stores a processing condition pattern number, for an input source in advance;

a processing condition list that stores a start condition, an ending condition and an output destination, an intermediate condition for conducting aggregation processing at an intermediate point and the output destination, for the processing condition pattern number;

an intermediate data table that stores a value to be aggregated and a completion flag, for a key value; and

a processing unit,

wherein the processing unit reads the respective divided input data in a case where a string of data having start and ending information separately arrives at the processing unit from an external system,

the processing unit discriminates whether the input data is transmitted from any input source,

the processing unit acquires a key value for identifying the string of data, a determination value in advancing processing, the value to be aggregated, and the processing condition pattern number, from the input data and the input source, with reference to the pattern determination table,

the processing unit registers the key value and the value to be aggregated which are acquired from the input data, and the completion flag set to “not output” in the intermediate data table, and

the processing unit conducts ending processing for calculating an aggregation result obtained by aggregating the values to be aggregated of one or a plurality of records of the same key value as the key value of the input data from the intermediate data table when the determination value satisfies the ending condition or the intermediate condition with reference to the processing condition list, completion flag edition processing for updating the completion flag of the one or the plurality of records as “already output”, and output processing for outputting the key value and the aggregation result to an output destination obtained with reference to the processing condition list.

According to the present invention, it is possible to improve usability and a processing speed by waiting for a string of information associated with each other, and appropriately aggregating data satisfying a specific condition when outputting the data, and retaining and storing the aggregated data.

### BRIEF DESCRIPTION OF THE DRAWINGS

FIG. 1 is a diagram illustrating a system according to this embodiment;

FIG. 2 is a diagram illustrating a processing sequence;

FIG. 3 is a configuration diagram illustrating requirements configuring the system;

FIG. 4 is an illustrative view illustrating an example of an input determination list for determining an input source according to data arriving at an input unit;

FIG. 5A is an illustrative view illustrating an example of input data;

FIG. 5B is an illustrative view illustrating an example of divided input data;

FIGS. 6A and 6B are illustrative views illustrating examples of a table of data store used in discriminating a pattern of the input data;

FIG. 7 is an illustrative view illustrating an example of lists describing rules of start/ending/intermediate conditions;

FIG. 8 is a flowchart illustrating aggregation processing;

FIGS. 9A and 9B are illustrative views illustrating examples of a table of data store used in retaining and storing data;

FIGS. 9C and 9D are illustrative views illustrating examples of a table of data store used in retaining and storing data which has been file-output;

FIG. 10 is an illustrative view illustrating an example of data of an output unit; and

FIG. 11 is a diagram illustrating a physical configuration of the system.

### DETAILED DESCRIPTION OF THE INVENTION

In this embodiment, particularly, in a case where a string of information originally associated with each other arrives at an input unit, separately, a processing pattern is determined on the basis of information on an input source, processing conditions for waiting for the associated information are set, individually, data storage is controlled in conformity with the processing conditions, a string of data is retained in association with each other, and an aggregation result of the data retained at a set timing is output. Also, in this embodiment, the string of unnecessary data can be deleted in a lump to make an effective use of a resource.

Hereinafter, embodiments will be described with reference to the accompanying drawings.

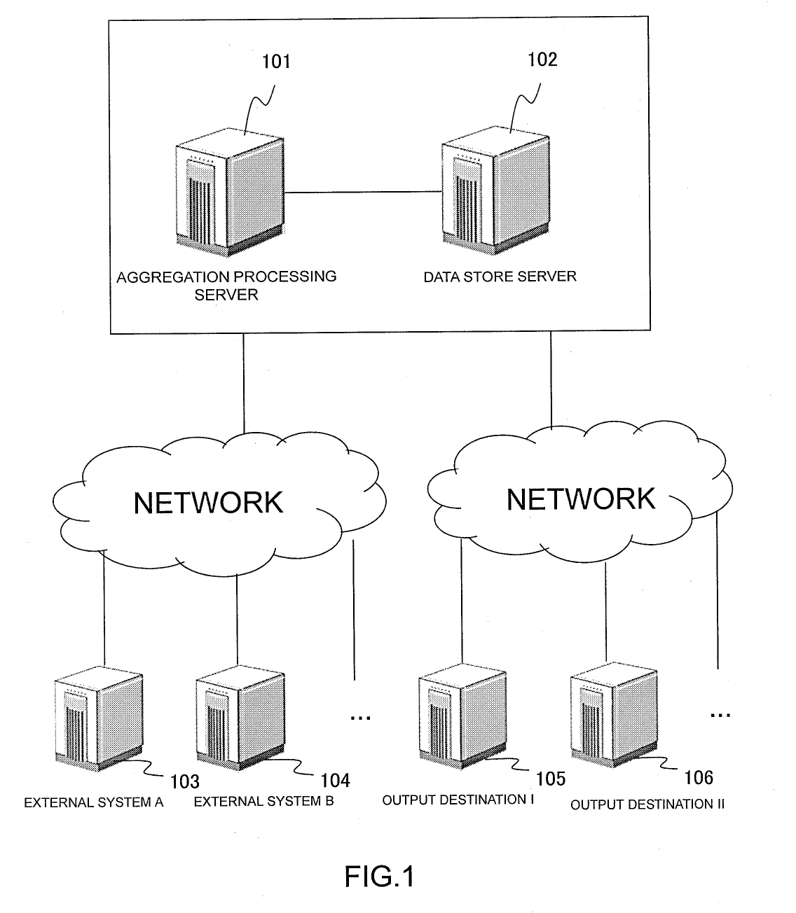

FIG. 1 is a diagram illustrating a system according to this embodiment. The system includes an aggregation processing server 101, and a data store server 102. In this system, for example, data different in format and structure which is received from a plurality of external systems A103 and B104 is subjected to editing operation, and aggregation results are output to an arbitrary output destination I 105 or II 106.

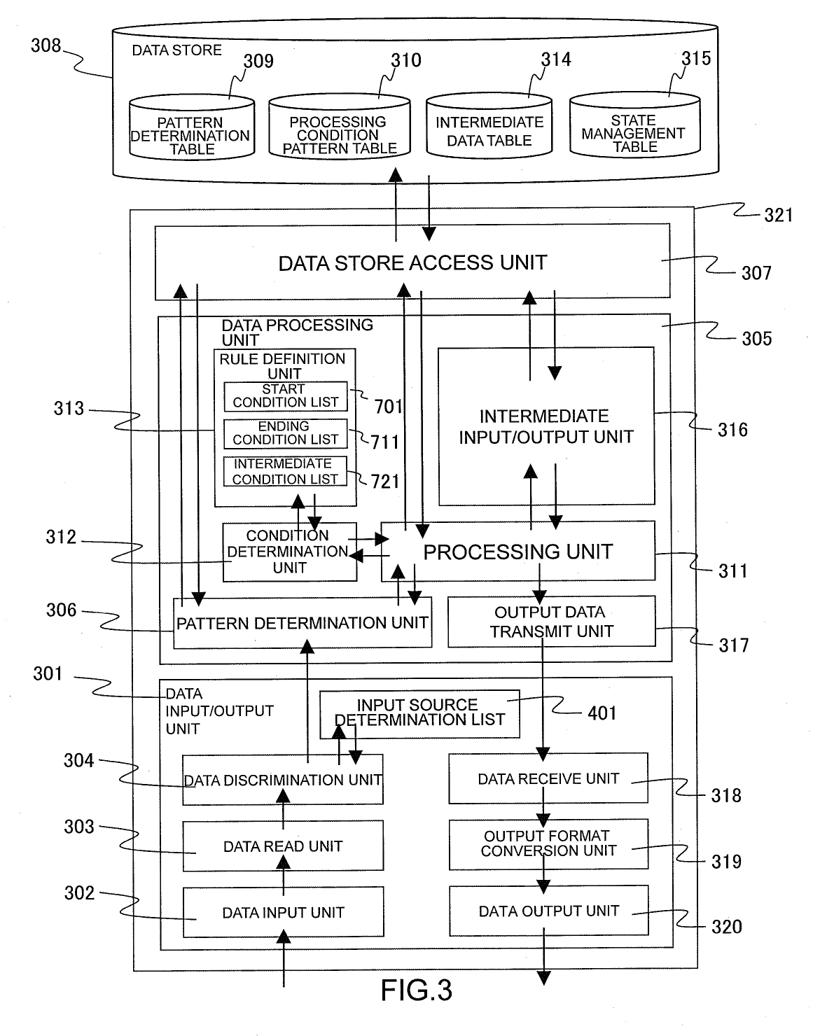

Also, FIG. 3 is a configuration diagram illustrating requirements configuring the system. An aggregation processing system 321 in FIG. 3 is realized by the aggregation processing server 101. Likewise, a data store 308 is realized by the data store server 102.

The aggregation processing system 321 includes a data input/output unit 301, a data processing unit 305, and a data store access unit 307. The data input/output unit 301 includes a data input unit 302, a data read unit 303, a data discrimination unit 304, a data receive unit 318, an output format conversion unit 319, a data output unit 320, and an input source determination list 401. The data processing unit 305 includes a pattern determination unit 306, a processing unit 311, a condition determination unit 312, a rule definition unit 313, an intermediate input/output unit 316, and an output data transmit unit 317. The rule definition unit 313 includes a start condition list 701, an ending condition list 711, and an intermediate condition list 721.

The data store 308 includes a pattern determination table 309 and a processing condition pattern table 310.

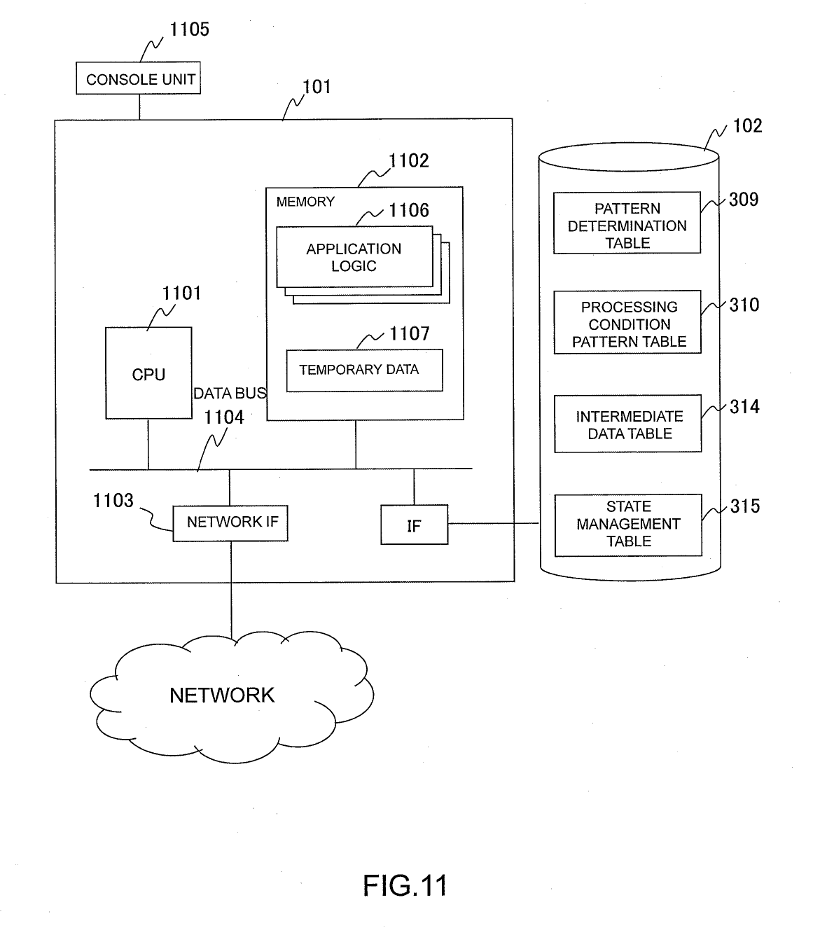

FIG. 11 is a diagram illustrating a physical configuration of the system. In the aggregation processing server 101, a CPU 1101, a memory 1102, and a network interface 1103 are connected to each other by a data bus 1104 to conduct the respective communications through the data bus 1104. Also, the aggregation processing server 101 is connected with a console unit 1105. The memory 1102 stores an application logic 1106 for conducting aggregation processing and output processing, and temporary data 1107 therein. The aggregation processing server 101 and the data store server 102 are connected to each other through an interface (IF) by the data bus 1104. The aggregation processing server 101 uses the respective tables such as the pattern determination table 309, the processing condition pattern table 310, an intermediate data table 314, and a state management table 315 on the data store server 102 for acquisition of the processing pattern, and storage and retention of the intermediate data. The data store is configured by, for example, an in-memory DB, but may be formed by another storage configuration such as a hard disk drive. The CPU 1101 (processing unit) can include the data processing unit 305 and the data input/output unit 301.

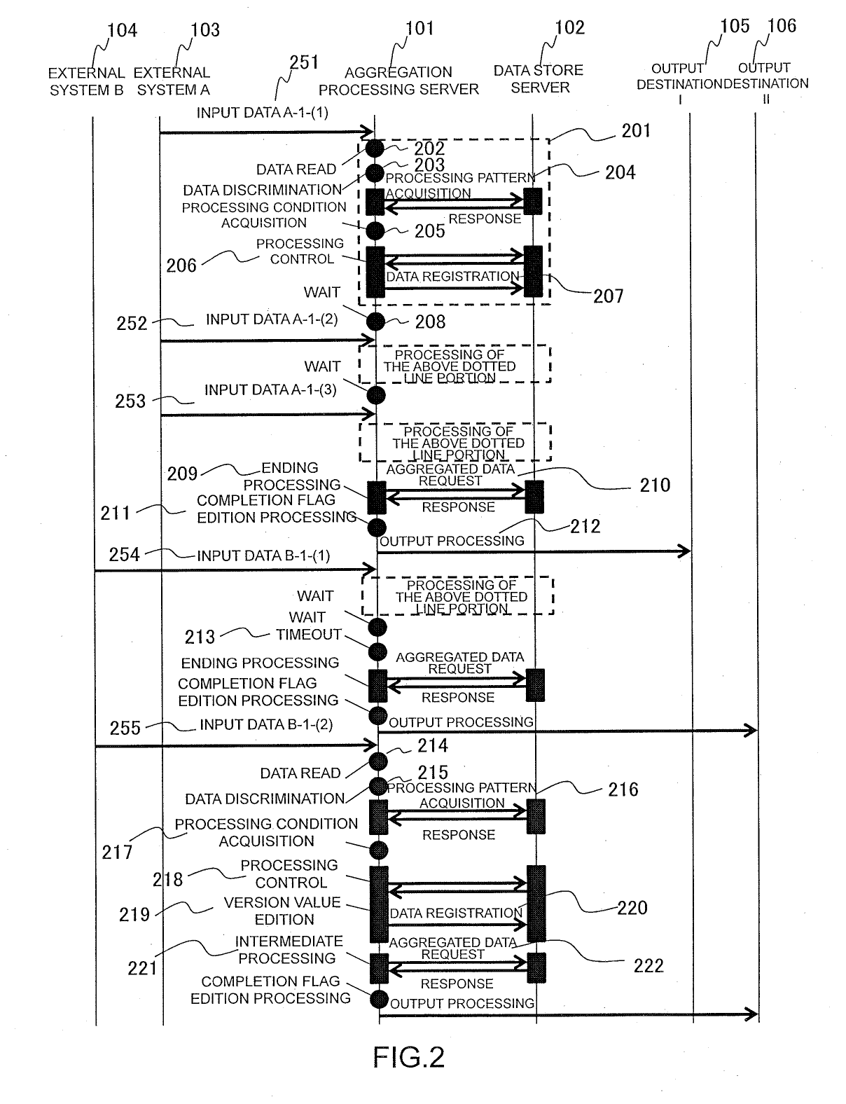

FIG. 2 is a processing sequence diagram. When input data A-1-(1) 251 is transmitted to the aggregation processing server 101 from an external system A 103, the aggregation processing server 101 executes processing 201 for reading and registering the data.

In the processing 201, data read processing 202 is first conducted. In this read processing, the input data is received by the data input unit 302 in the data input/output unit 301 of FIG. 3, the received data is read by the data read unit 303 according to a format.

The aggregation processing server 101 conducts data discrimination processing 203 subsequent to the data read processing 202. The data discrimination unit 304 discriminates whether the input data is transmitted from any source (input source), and provides information on the input source indicative of data from an input source A. In order to discriminate the input source, the data discrimination unit 304 sets the input source determination list 401 in advance.

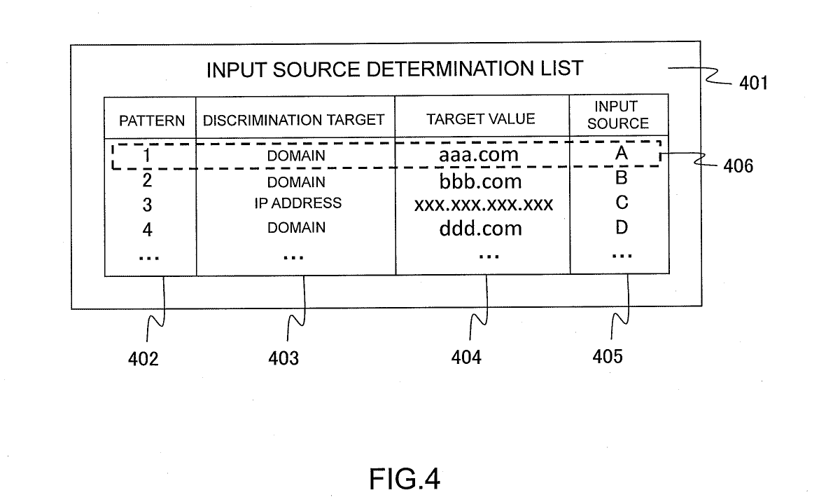

FIG. 4 is an illustrative view illustrating an example of an input determination list for determining the input source according to data arriving at the input unit. The input source determination list 401 stores a pattern 402, a discrimination target 403, a target value 404, and an input source 405 in association with each other therein in advance. The type of information on the discrimination target associated with the input data is prescribed by the discrimination target 403, and its value is set in the target value 404. The data discrimination unit 304 searches the coincident combination of the discrimination target 403 with the target value 404 in the input source determination list 401, determines the corresponding input source 405, and provides the information.

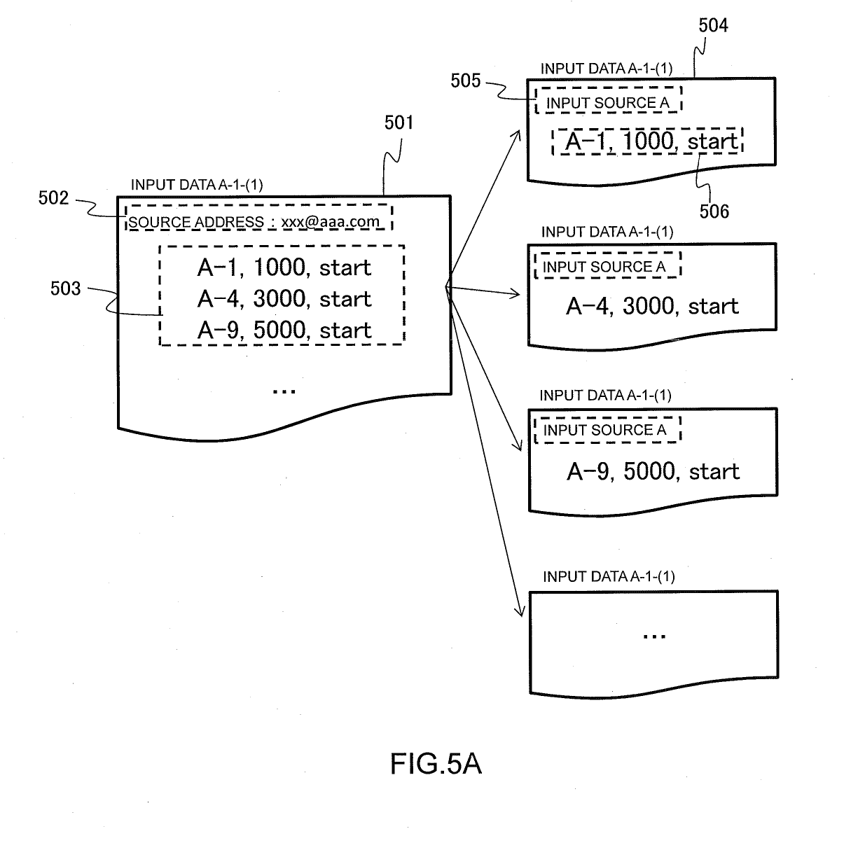

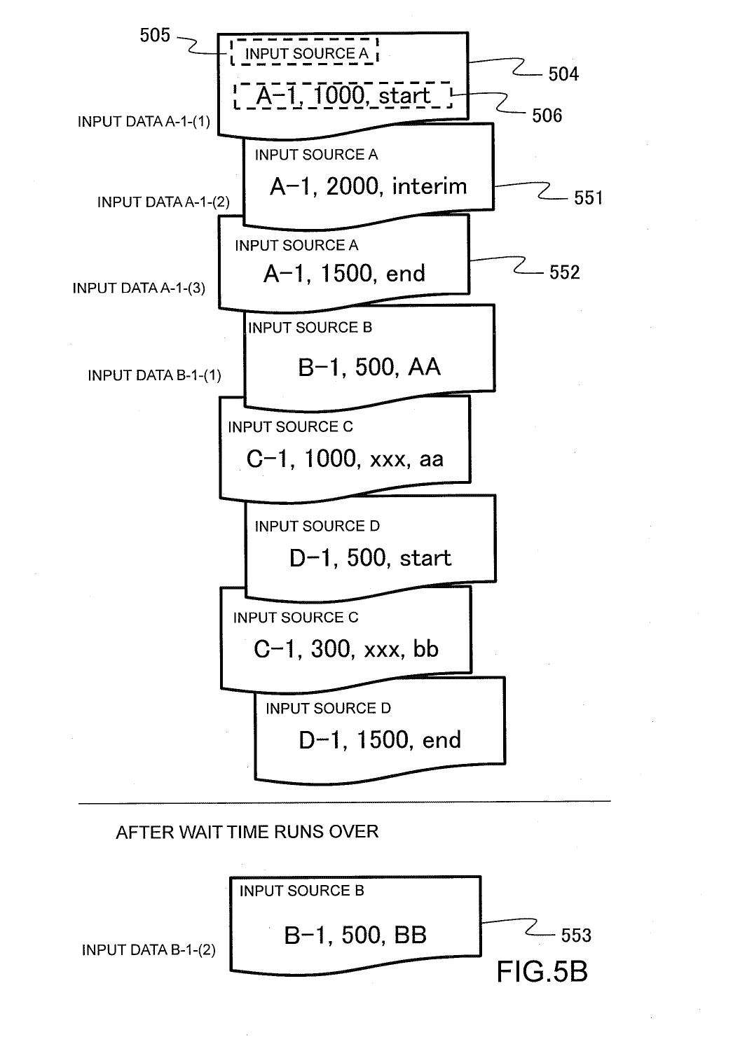

FIG. 5A is an illustrative view illustrating an example of the input data received by the data input unit 302. Data 501 represents an example of the above-mentioned input data A-1-(1). The data discrimination unit 304 determines the input source for the input data on the basis of the information associated with the input data with reference to the input source determination list 401. In this case, for example, based on a source address 502, the coincident combination of its domain with the target value is searched in the input source determination list 401 in order starting from a pattern 1, and it is discriminated that the input source is “A” according to an appropriate record 406. Also, the data discrimination unit 304 divides plural pieces of information 503 included in the input data, individually, and allocates the input source information to the individual data. Data 504 represents one piece of data divided, individually, and includes an allocated input source 505, and information 506 of one data unit therein. The data discrimination unit 304 transmits the respective divided data to which the input source is allocated to the data processing unit 305 from the data input/output unit 301.

Subsequently, processing pattern acquisition processing 204 is conducted. In this processing, the pattern determination unit 306 acquires the processing pattern with reference to a pattern determination table, which is registered on the data store 308 in advance, on the basis of the above-mentioned input source 505.

FIG. 5B is an illustrative view illustrating an example of input data that arrives at the data processing unit. FIG. 5B shows data transmitted from the data input/output unit 301 to the data processing unit 305. The information on the input source 505 and the information 506 on one data unit are included in the input data 504. For the purpose of processing the pattern acquisition, the pattern determination unit 306 accesses to the pattern determination table 309 of the data store 308 through the data store access unit 307.

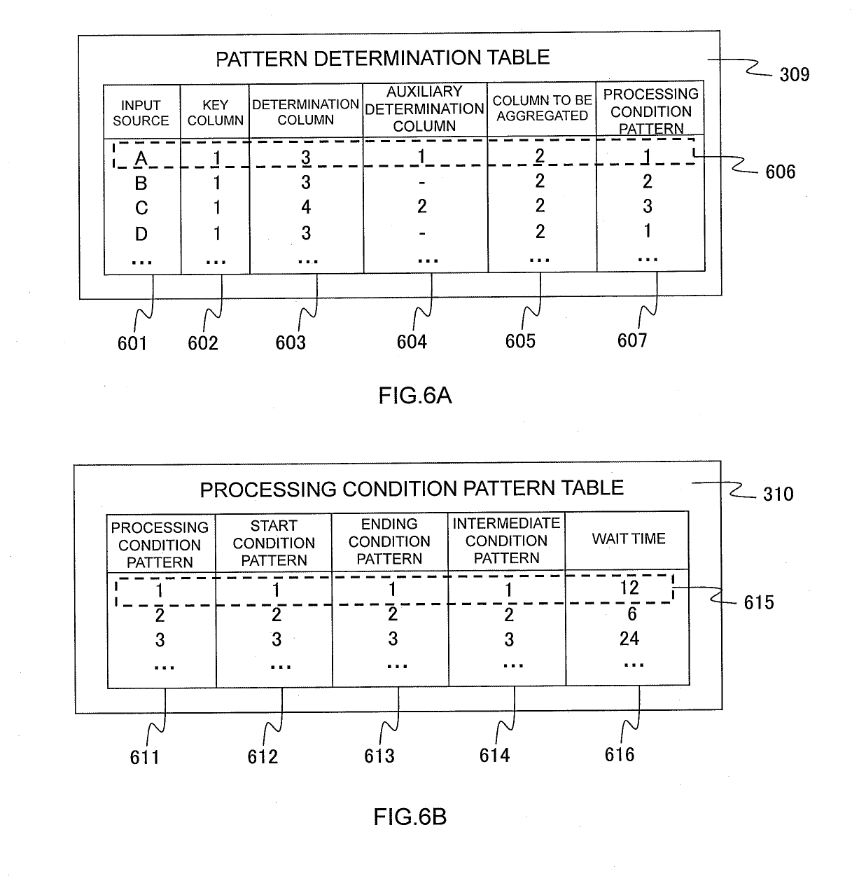

FIG. 6A is an illustrative view illustrating an example of a pattern determination table. The pattern determination table 309 stores an input source 601, a key column 602, a determination column 603, an auxiliary determination column 604, a column to be aggregated 605, and a processing condition pattern (number) 607 in association with each other in advance. The string of associated information can be identified by the key value of the input data indicated by the key column. The pattern determination unit 306 reads the record in which the input source 505 of the input data matches the input source 601 of the pattern determination table 309, with reference to the pattern determination table 309. Then, the pattern determination unit 306 acquires such information that what number of column is set as the key value at the time of data registration, what number of column is set as the determination value or the auxiliary determination value when advancing the processing, or what number of column is set as the value to be aggregated, among the columns of the information 506 in FIG. 5B, from the set values from the key column 602 to the column to be aggregated 605. Also, the processing condition pattern 607 indicates the processing condition pattern for conducting the start and ending processing in conducting the aggregation processing. The pattern determination unit 306 acquires any processing condition pattern on the basis of the input source. For example, if the pattern acquisition processing is conducted on the data 504, because the input source 505 is “A”, a record 606 indicated in FIG. 6 is coincident with the input source 505. The pattern determination unit 306 sets a first value (“A-1” of the information 506 in FIG. 5B) as the key value on the basis of the key column 602, sets a third value (“start” of the information 506 in FIG. 5B) as the determination value when advancing the processing on the basis of the determination column 603, sets the first value (“A-1” of the information 506 in FIG. 5B) as the auxiliary determination value when advancing the processing on the basis of the auxiliary determination column 604, and sets a second value (“1000” of the information 506 in FIG. 5B) as the value to be aggregated on the basis of the column to be aggregated 605, for data of the input source A according to the set value of the record. The value to be determined can thus take values such as “start” or “end”, or may be completely different values. Also, in this example, the processing condition pattern is “1”.

Subsequently, processing condition acquisition processing 205 is conducted. In this processing, the data processing unit 305 (pattern determination unit 306) acquires the processing condition pattern set in advance from the processing condition pattern table 310 of the data store 308 on the basis of the set value of the above-mentioned processing condition pattern 607.

FIG. 6B is an illustrative view illustrating an example of the processing condition pattern table 310. The processing condition pattern table 310 stores a processing condition pattern 611 associated with the pattern determination table 309, a start condition pattern 612 representative of the pattern of the start condition, an ending condition pattern 613 representative of the pattern of the ending condition, an intermediate condition pattern 614 representative of the pattern of the condition for conducting the aggregation processing at the intermediate point, and a wait time 616 in association with each other in advance. The set values 612 to 614 indicate definition numbers of the respective conditions defined, separately. For example, if the processing condition pattern is “1” as indicated by the record 606 of FIG. 6, the processing condition pattern is determined on the basis of the respective set values indicated by a record 615. That is, the data processing unit 305 (pattern determination unit 306) starts the aggregation processing if the condition defined as the start condition pattern “1”, separately, is satisfied. Likewise, the data processing unit 305 terminates the aggregation processing if the condition defined as the ending condition pattern “1”, separately, is satisfied. Also, the data processing unit 305 conducts the aggregation processing at the intermediate point if the condition defined as the intermediate processing condition pattern “1”, separately, is satisfied (refer to an ending processing 209, a completion flag edition processing 211, and an output processing 212).

The data processing unit 305 controls the processing based on those processing patterns, and the processing conditions associated with those processing patterns under a processing control 206 of FIG. 2. The processing control is conducted by the processing unit 311, and the determination of whether to acquire the conditions, and whether to satisfy the conditions is conducted by the condition determination unit 312. Also, the definitions of the respective conditions are set in the rule definition unit 313 in advance, separately.

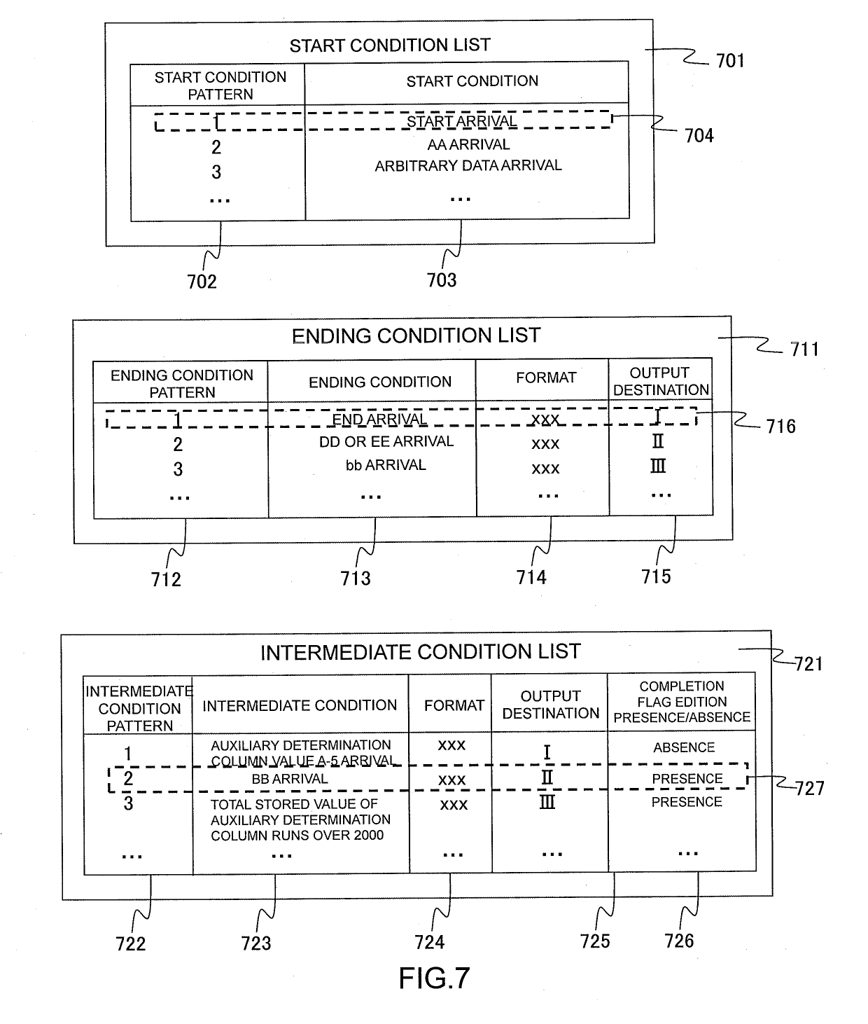

FIG. 7 is an illustrative view illustrating an example of the respective condition lists. The start condition list 701 stores a start condition pattern 702 associated with the start condition pattern 612 of FIG. 6B, and a start condition 703 in association with each other in advance. The respective condition lists of FIG. 7 and the processing condition pattern in FIGS. 6A and 6B are exemplary, and information on those condition patterns may be called “processing condition list”. If the condition determination unit 312 determines that a value of data corresponding to the column number set in the determination column 603 of FIG. 6A satisfies the start condition 703, the processing unit 311 of FIG. 3 starts the aggregation processing. For example, when the data 504 indicated in FIG. 5A is received, because the value to be determined is “start”, and the start condition indicated by a record 704 is satisfied, the processing unit 311 starts the aggregation processing for storing the string of data associated with each other.

Likewise, the ending condition list 711 stores an ending condition pattern 712 associated with the ending condition pattern 613 in FIG. 6B, an ending condition 713, a format 714, and an output destination 715 in association with each other in advance. If the condition determination unit 312 determines that a value of data corresponding to a column number set in the determination column 603 in FIG. 6A satisfies the ending condition 713, the processing unit 311 in FIG. 3 terminates the aggregation processing, conducts the aggregation processing of the string of data, and outputs the result to the output destination 715 according to the format prescribed in the format 714. For example, when data 552 indicated in FIG. 5A is received, the value to be determined is “end”, and the ending condition indicated by a record 716 is satisfied, the processing unit 311 conducts the aggregation processing and the output processing (refer to the ending processing 209, the completion flag edition processing 211, and the output processing 212).

The intermediate condition list 721 stores an intermediate condition pattern 722 associated with the intermediate condition pattern 614 of FIG. 6, an intermediate condition 723, a format 724, an output destination 725, and a completion flag edition presence/absence 726 in association with each other in advance. If the condition determination unit 312 determines that a value of the data corresponding to the column number set in the determination column 603 of FIG. 6 satisfies the intermediate condition 723, the processing unit 311 conducts the aggregation and output processing (refer to the ending processing 209, the completion flag edition processing 211, and the output processing 212) as in the above-mentioned ending processing. For example, when data 553 indicated in FIG. 5B is received, because the value to be determined is “BB”, and the intermediate condition indicated by a record 727 is satisfied, the processing unit 311 conducts the aggregation processing and the output processing (refer to the ending processing 209 and the output processing 212). In this situation, whether a completion flag to be described later, which indicates that the output data has already been output, is edited, or not, is set in the completion flag edition presence/absence 726. If the condition determination unit 312 determines that the completion flag edition presence/absence 726 is set as presence, the processing unit 311 executes the completion flag edition processing 211.

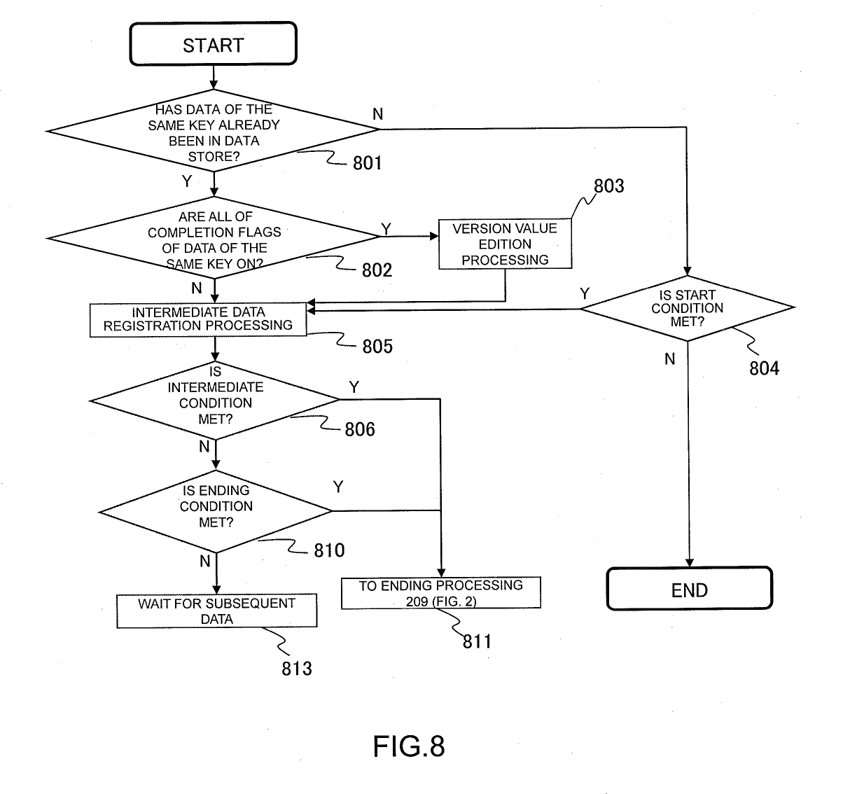

FIG. 8 illustrates a processing flow in the above-mentioned processing control 206. A control of processing in FIG. 8 is conducted by the processing unit 311 of FIG. 2.

First, in Step 801, the processing unit 311 accesses to the intermediate data table 314 in FIG. 3 for the purpose of confirming storage data stored in the data store 308.

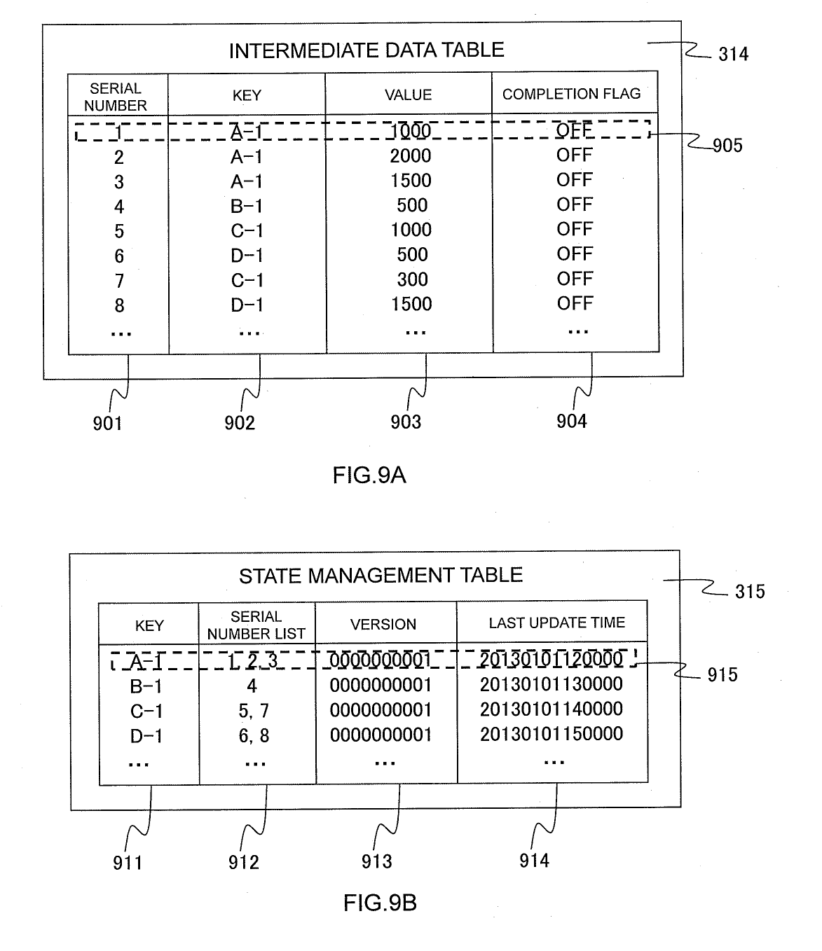

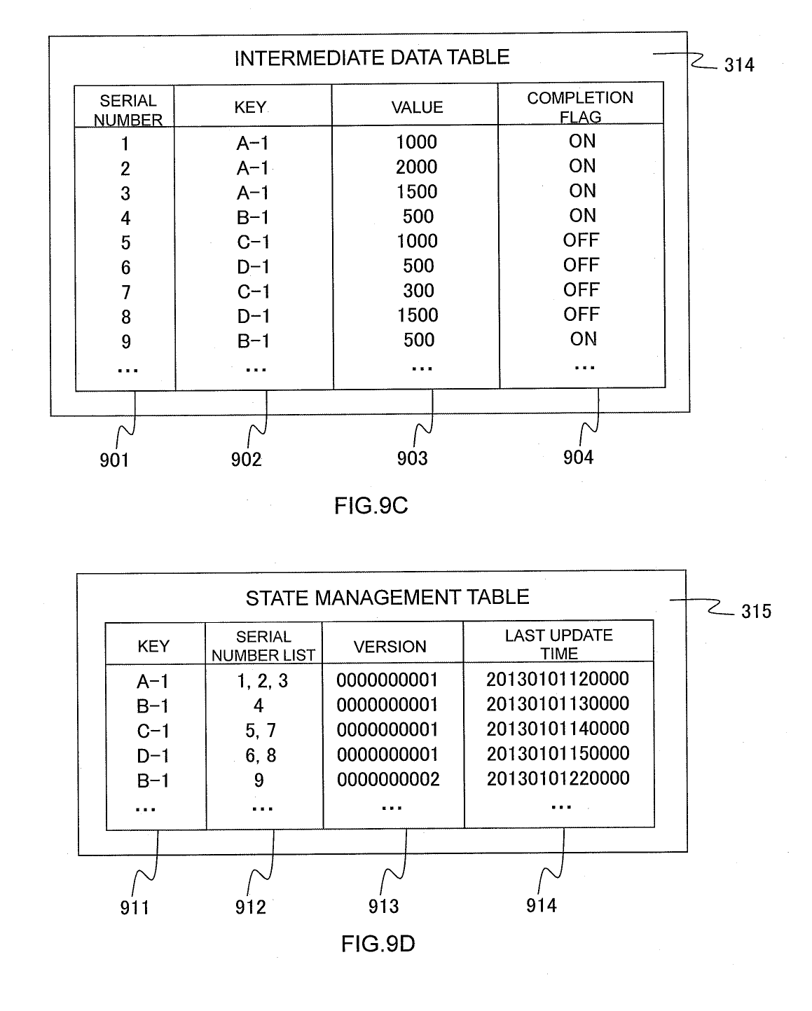

FIG. 9A is an illustrative view illustrating the intermediate data table 314. The intermediate data table 314 includes a serial number 901, a key 902, a value 903, and a completion flag 904. In this example, the completion flag 904 of “off” is indicative of “not output”, and the completion flag 904 of “on” is indicative of “already output”.

In Step 801, the processing unit 311 determines whether data having the same key as a value of the key column of the received data has already been present in the table, or not, to discriminate whether data having the same type as that of the data presently dealt with has been registered in the past, or not. If the discrimination result is yes, the flow proceeds to Step 802, and if the discrimination result is no, the flow proceeds to Step 804.

In Step 802, the processing unit 311 determines whether all of the completion flags 904 of the data of the same key are on, or not, to discriminate whether the data presently dealt with has already been output, or not. If the discrimination result is yes, the flow proceeds to Step 803, and if the discrimination result is no, the flow proceeds to Step 805.

In Step 803, the processing unit 311 conducts version value edition processing. In this Step 803, because the processing unit 311 registers the present data in distinction from the records of the same key which have been registered and output by then, the processing unit 311 updates version information managed in the state management table 315 of the data store.

FIG. 9B is an illustrative view illustrating the state management table 315. The state management table 315 includes a key 911, a serial number list 912, a version 913, and a last update time 914. The processing unit 311 groups and manages the records in the intermediate data table 314 for each key according to the state management table 315, and increments a value of the version of the output record for management with distinction.

In Step 804, the processing unit 311 determines whether the data currently dealt with satisfies the start condition, or not. If the determination result is yes, the flow proceeds to Step 805, and if the determination result is no, the processing flow is terminated.

In Step 805, the processing unit 311 conducts intermediate data registration processing 207 illustrated in FIG. 2. In this processing, the processing unit 311 registers the key column of data currently dealt with, and the value of the column to be aggregated in the intermediate data table 314 of FIG. 9A through the intermediate input/output unit 316 of FIG. 3. In this situation, the processing unit 311 registers the completion flag 904 as a default value with off. This value is updated to on when outputting the data later. As an example, the input data 504 is registered in a record 905 of FIG. 9A.

In Step 806, the processing unit 311 determines whether the value (determination value) of the determination column of data currently dealt with satisfies the intermediate condition, or not, to discriminate whether the storage data of the same key at that time is aggregated and output, or not. The intermediate condition obtains the intermediate condition pattern with reference to the processing condition pattern table 310 according to the processing condition pattern, and can obtain the intermediate condition list 721 by search on the basis of the intermediate condition pattern. In this example, if the result of determining whether the intermediate condition is met, or not, is yes, the flow proceeds to the ending processing 209 (FIG. 2) of Step 811. If the result is no, the flow proceeds to Step 810.

In Step 810, the processing unit 311 determines whether the value (determination value) of the determination column of data currently dealt with satisfies the ending condition, or not. The ending condition obtains the ending condition pattern with reference to the processing condition pattern table 310 according to the processing condition pattern, and can obtain the ending condition list 711 by search on the basis of the ending condition pattern. In this example, if the result of determining whether the ending condition is met, or not, is yes, the flow proceeds to the ending processing 209 (FIG. 2) of Step 811. If the result is no, the flow proceeds to Step 813.

In Step 813, the processing unit 311 conducts processing for waiting for the subsequent data of the same key to be received.

When the wait processing is conducted as a result of determination in the above-mentioned processing flow, the processing unit 311 conducts waiting 208 illustrated in FIG. 2. The wait processing will be described later.

If a subsequent data A-1-(2) 252 is transmitted to the aggregation processing server 101 from the external system A before the flow proceeds to the ending processing 209, the aggregation processing server 101 repeats the same processing as that in the case of A-1-1, and determines whether the intermediate condition and the ending condition of the rule definition unit are satisfied, or not. If none of those conditions is satisfied, the aggregation processing server 101 merely registers data in the data store server 102 (intermediate data table 314), and does not output the data. In this situation, the serial number of the registered data is added to the serial number list 912 of the records having the same key in the state management table 315.

Further, if a subsequent data A-1-(3) 253 is transmitted to the aggregation processing server 101 from the input source, the aggregation processing server 101 conducts the same processing. For example, if the ending condition is satisfied, the aggregation processing server 101 registers the data, and then conducts the ending processing 209. Even if the intermediate condition is satisfied in the halfway data, the aggregation processing server 101 registers the data, and then conducts the ending processing 209. Also, the serial number of the registered data is added to the serial number list 912 of the records having the same key in the state management table 315. As an example, the input data 504, 551, and 552 illustrated in FIG. 5 are registered in a record 915 of FIG. 9B.

In the ending processing 209, the processing unit 311 gives an aggregated data request 210 to the data store server 102 for the purpose of outputting the aggregated data of the same key at that time, and receives the records of the same key within the intermediate data table 314 as response information. The processing unit 311 aggregates the value to be aggregated of the records having the same key. For example, in the records illustrated in FIG. 9A, “4500” which is a total of values “1000”, “2000”, and “1500” having the key value of “A-1” is an aggregation result.

Subsequently, the aggregation processing server 101 updates the completion flag 904 of the record output from the intermediate data table 314 and used for aggregation in the completion flag edition processing 211 to on.

Then, in the output processing 212, the processing unit 311 transmits the aggregated data from the output data transmit unit 317 of FIG. 3 to the data input/output unit 301, and outputs the aggregation results to the output destination I 105.

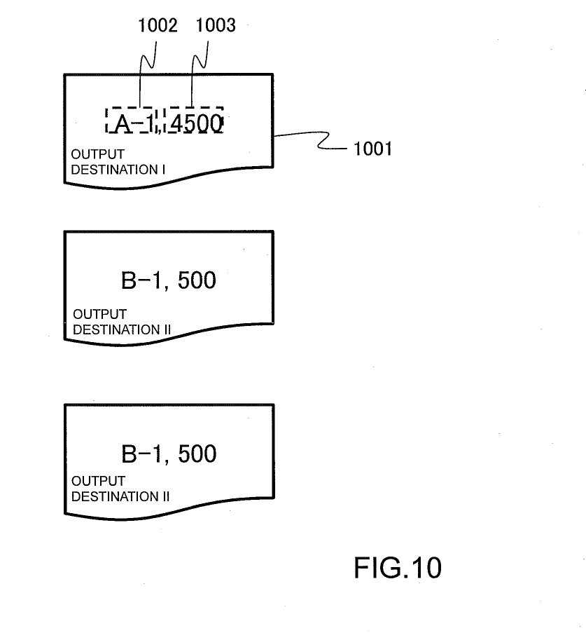

FIG. 10 illustrates an example of the output data. Output data 1001 includes a key 1002 and an aggregated value 1003. The aggregated value 1003 represents a value obtained by aggregating a sequence of value 903 in the intermediate data table 314 belonging to the same key in the state management table 315. Also, the output data is output for each of the output destination 715 of the ending condition list 711 or the output destination described in the output destination 725 of the intermediate condition list 721.

Also, when an input data B-1-(1) 254 is transmitted to the aggregation processing server 101 from an external system B 104, the aggregation processing server 101 conducts the processing in the same manner as that when the data is transmitted from the external system A. On the other hand, for example, if the wait time 616 set in the processing condition pattern table 310 runs over when the wait processing of the subsequent data is conducted after the aggregation processing of the string of data has started, after a wait timeout 213 is conducted, and the completion flag is updated, the data output processing of the data aggregated by then may be conducted.

Thereafter, a case in which an input data B-1-(2) 255 is transmitted to the aggregation processing server 101 is assumed as indicated by the data 553 in FIG. 5B. In this example, since the input source is “B”, and the determination column is “3”, the value to be determined is “BB”, and since the processing condition pattern is “2”, the intermediate condition 727 is met. In this case, after the aggregation processing server 101 conducts data read 214, data discrimination 215, processing pattern acquisition 216, and processing condition acquisition 217, the aggregation processing server 101 conducts a processing control 218. The aggregation processing server 101 conducts version value edition 219 to increment the value of the version 913 of the state management table 315 from the version when registering B-1-(1), and registers the incremented value in subsequent data registration processing 220 as a new grouping.

Also, for example, the intermediate condition is met, the processing unit 311 conducts intermediate processing 221, and gives an aggregated data request 222 to the data store server for the purpose of outputting the aggregated data at that time. If the completion flag edition presence/absence 726 of the intermediate condition list 721 is set as “presence”, the processing unit 311 updates the completion flag of the output record to on, and outputs the aggregation result.

FIGS. 9C and 9D are illustrative views illustrating an example of the updated record. In this example, the aggregation processing server 101 outputs data 251, 252, 253, 254, and 255 illustrated in the figure. If the completion flag is not set to be edited at the time of output by the completion flag edition presence/absence 726 of the intermediate condition list 721, the processing unit 311 does not update the completion flag.

Also, the processing unit 311 determines whether the completion flag edition presence/absence 726 of the intermediate condition list 721 is set as “presence”, or not, to determine whether the record output as the intermediate state is treated as “already output”, or not. If the output information is unnecessary, the processing unit 311 deletes the output information in a lump on the basis of the completion flag and the version information to effectively use the resource. The last update time 914 is updated every time the data of the same key is registered. When the wait time is measured, the processing unit 311 calculates how long time elapses since the previous data is registered on the basis of the last update time 914.

As described above, according to this embodiment, the input data aggregation processing apparatus having the aggregation processing server and device and the data store server and device waits for the string of associated information, and appropriately aggregates, retains, and stores the data that satisfies the specific conditions when outputting the data, as a result of which the usability and the processing speed can be improved.

Also, according to this embodiment, unnecessary data is deleted, and necessary data is retained and stored so that unnecessary use of the resource can be avoided.

The present invention is not limited to the above embodiments, but includes various modified examples. For example, in the above-mentioned embodiments, in order to easily understand the present invention, the specific configurations are described. However, the present invention does not always provide all of the configurations described above. Also, apart of one configuration example can be replaced with another configuration example, and the configuration of one embodiment can be added with the configuration of another embodiment. Also, in a part of the respective configuration examples, another configuration can be added, deleted, or replaced.

Also, parts or all of the above-described respective configurations, functions, processors, processing means may be realized, for example, as an integrated circuit, or other hardware. Also, the above respective configurations and functions may be realized by allowing the processor to interpret and execute programs for realizing the respective functions. That is, the respective configurations and functions may be realized by software. The information on the program, table, and file for realizing the respective functions can be stored in a storage device such as a memory, a hard disc, or an SSD (solid state drive), or a storage medium such as an IC card, an SD card, or a DVD.

Also, the control lines and the information lines necessary for description are illustrated, and all of the control lines and the information lines necessary for products are not illustrated. In fact, it may be conceivable that most of the configurations are connected to each other.

What is claimed is:

1. An input data aggregation processing apparatus, comprising:
a pattern determination table that stores a processing condition pattern number, for an input source in advance;
a processing condition list that stores a start condition, an ending condition and an output destination, an intermediate condition for conducting aggregation processing at an intermediate point and the output destination, for the processing condition pattern number;
an intermediate data table that stores a value to be aggregated and a completion flag, for a key value; and
a processing unit,
wherein the processing unit reads the respective divided input data in a case where a string of data having start and ending information separately arrives at the processing unit from an external system,
the processing unit discriminates whether the input data is transmitted from any input source,
the processing unit acquires a key value for identifying the string of data, a determination value in advancing processing, the value to be aggregated, and the processing condition pattern number, from the input data and the input source, with reference to the pattern determination table,
the processing unit registers the key value and the value to be aggregated which are acquired from the input data, and the completion flag set to “not output” in the intermediate data table, and
the processing unit conducts ending processing for calculating an aggregation result obtained by aggregating the values to be aggregated of one or a plurality of records of the same key value as the key value of the input data from the intermediate data table when the determination value satisfies the ending condition or the intermediate condition with reference to the processing condition list, completion flag edition processing for updating the completion flag of the one or the plurality of records as “already output”, and output processing for outputting the key value and the aggregation result to an output destination obtained with reference to the processing condition list.

2. The input data aggregation processing apparatus according to claim 1,
wherein the processing unit includes an input source determination list that stores the input source for a discrimination target and a target value in advance, and
the processing unit obtains the input source on the basis of a combination of the discrimination target and the target value included in the input data, from the input source determination list.

3. The input data aggregation processing apparatus according to claim 1,
wherein the pattern determination table stores a key column indicative of what number of data in the input data is set as the key value at the time of data registration, a determination column indicative of what number of data is set as the determination value in advancing the processing, a column to be aggregated indicative of what number of data is set as the value to be aggregated, and the processing condition pattern number in association with each other, for each input source in advance, and
the processing unit acquires the key value, the determination value, the value to be aggregated, and the processing condition pattern number on the basis of the input source with reference to the pattern determination table.

4. The input data aggregation processing apparatus according to claim 1,
wherein the processing condition list includes:
a processing condition pattern table that stores a start condition pattern number, an ending condition pattern number, and an intermediate condition pattern number for the processing condition pattern number therein,
a start condition list that stores a start condition for the start condition pattern number in advance,
an ending condition list that stores the ending condition and the output destination for the ending condition pattern number in advance, and
an intermediate condition list that stores the intermediate condition and the output destination for the intermediate condition pattern number in advance,
wherein the processing unit obtains the start condition list, the ending condition list, and the intermediate condition list on the basis of the start condition pattern number, the ending condition pattern number, and the intermediate condition pattern number, which are obtained from the processing condition pattern table, according to the processing condition pattern number, and determines whether the determination value satisfies the start condition, the ending condition, or the intermediate condition, or not.

5. The input data aggregation processing apparatus according to claim 4, further comprising:
a data store unit including the pattern determination table, the processing condition pattern table, and the intermediate data table; and
an aggregation processing unit having the processing unit, the start condition list, the ending condition list, and the intermediate condition list.

6. The input data aggregation processing apparatus according to claim 4,
wherein the intermediate condition list further includes a completion flag edition presence/absence information in correspondence with the processing condition pattern,
the processing unit executes the completion flag edition processing if the completion flag edition presence/absence information is indicative of presence, and
the processing unit does not execute the completion flag edition processing if the completion flag edition presence/absence information is indicative of absence.

7. The input data aggregation processing apparatus according to claim 1,
wherein the processing unit determines whether the data having the same key value as the key value of the input data has already been present in the intermediate data table, or not, to discriminate whether data having the same type as that of the input data presently dealt with has been registered in the intermediate data table in the past, or not.

8. The input data aggregation processing apparatus according to claim 1,
wherein, if the input data satisfies the start condition, or if all of the completion flags of the record of the same key value within the intermediate data table are not indicative of completion,
the processing unit registers the key value of the input data and the value to be aggregated in the intermediate data table, and registers the completion flag as “not output”.

9. The input data aggregation processing apparatus according to claim 1,
wherein the processing condition pattern table further includes a wait time in correspondence with the processing condition pattern number,
the processing unit waits for subsequent data of the same key value to be received on the basis of the wait time, and executes the ending processing, the completion flag edition processing, and the output processing if the wait time runs over.

10. The input data aggregation processing apparatus according to claim 1, further comprising: a state management table that stores number and version of the record of the intermediate data table in correspondence with the key value therein,
wherein the processing unit groups the records within the intermediate data table for each key, and increments the version of the output record.

11. The input data aggregation processing apparatus according to claim 1,
wherein the processing unit deletes the output data in a lump on the basis of the completion flag with reference to the intermediate data table.

12. An input data aggregation processing system, comprising an aggregation processing server which comprises:
a pattern determination table that stores a processing condition pattern number, for an input source in advance;
a processing condition list that stores a start condition, an ending condition and an output destination, an intermediate condition for conducting aggregation processing at an intermediate point and the output destination, for the processing condition pattern number;
an intermediate data table that stores a value to be aggregated and a completion flag, for a key value; and
a processing unit,
wherein the processing unit of the aggregation processing server reads the respective divided input data in a case where a string of data having start and ending information separately arrives at the processing unit from an external system,
the processing unit discriminates whether the input data is transmitted from any input source,
the processing unit acquires a key value for identifying the string of data, a determination value in advancing processing, the value to be aggregated, and the processing condition pattern number, from the input data and the input source, with reference to the pattern determination table,
the processing unit registers the key value and the value to be aggregated which are acquired from the input data, and the completion flag set to “not output” in the intermediate data table, and
the processing unit conducts ending processing for calculating an aggregation result obtained by aggregating the values to be aggregated of one or a plurality of records of the same key value as the key value of the input data from the intermediate data table when the determination value satisfies the ending condition or the intermediate condition with reference to the processing condition list, completion flag edition processing for updating the completion flag of the one or the plurality of records as “already output”, and output processing for outputting the key value and the aggregation result to an output destination obtained with reference to the processing condition list.

13. The input data aggregation processing system according to claim 12,
wherein the processing condition list includes:
a processing condition pattern table that stores a start condition pattern number, an ending condition pattern number, and an intermediate condition pattern number for the processing condition pattern number therein,
a start condition list that stores a start condition for the start condition pattern number in advance,
an ending condition list that stores the ending condition and the output destination for the ending condition pattern number in advance, and
an intermediate condition list that stores the intermediate condition and the output destination for the intermediate condition pattern number in advance,
wherein the processing unit obtains the start condition list, the ending condition list, and the intermediate condition list on the basis of the start condition pattern number, the ending condition pattern number, and the intermediate condition pattern number, which are obtained from the processing condition pattern table, according to the processing condition pattern number, and determines whether the determination value satisfies the start condition, the ending condition, or the intermediate condition, or not.

14. The input data aggregation processing system according to claim 13, further comprising:
a data store server including the pattern determination table, the processing condition pattern table, and the intermediate data table; and
an aggregation processing server having the processing unit, the start condition list, the ending condition list, and the intermediate condition list.

15. An input data aggregation processing method in an input data aggregation processing apparatus, the input data aggregation processing apparatus which comprises:
a pattern determination table that stores a processing condition pattern number, for an input source in advance;
a processing condition list that stores a start condition, an ending condition and an output destination, an intermediate condition for conducting aggregation processing at an intermediate point and the output destination, for the processing condition pattern number;
an intermediate data table that stores a value to be aggregated and a completion flag, for a key value; and
a processing unit,
wherein the processing unit reads the respective divided input data in a case where a string of data having start and ending information separately arrives at the processing unit from an external system,
the processing unit discriminates whether the input data is transmitted from any input source,
the processing unit acquires a key value for identifying the string of data, a determination value in advancing processing, the value to be aggregated, and the processing condition pattern number, from the input data and the input source, with reference to the pattern determination table,
the processing unit registers the key value and the value to be aggregated which are acquired from the input data, and the completion flag set to “not output” in the intermediate data table, and
the processing unit conducts ending processing for calculating an aggregation result obtained by aggregating the values to be aggregated of one or a plurality of records of the same key value as the key value of the input data from the intermediate data table when the determination value satisfies the ending condition or the intermediate condition with reference to the processing condition list, completion flag edition processing for updating the completion flag of the one or the plurality of records as “already output”, and output processing for outputting the key value and the aggregation result to an output destination obtained with reference to the processing condition list.
